(19) United States
(12) Patent Application Publication
(10) Pub. No.: US 2021/0276578 A1
(43) Pub. Date: Sep. 9, 2021

(54) VEHICLE INFORMATION PROCESSING APPARATUS

(71) Applicant: HONDA MOTOR CO., LTD., Tokyo (JP)

(72) Inventor: Kenya IKENAGA, Tokyo (JP)

(21) Appl. No.: 17/175,752

(22) Filed: Feb. 15, 2021

(30) Foreign Application Priority Data
Mar. 6, 2020 (JP) 2020-039159

(51) Int. Cl. B60W 50/02; B60W 50/04; B60W 50/14

(52) U.S. Cl. CPC B60W 50/0205; B60W 50/045; B60W 50/14; B60W 2554/4041; B60W 2050/0215; B60W 2556/65; B60W 2050/046

(57) ABSTRACT

A vehicle information processing apparatus includes a detection unit configured to detect a target outside a vehicle, a communication unit configured to obtain position information of another vehicle by vehicle-to-vehicle communication, and a determination unit configured to determine, based on the position information obtained by the communication unit and a detection result obtained by the detection unit, whether performance degradation of the detection unit has occurred.

### CROSS-REFERENCE TO RELATED APPLICATION(S)

This application claims priority to and the benefit of Japanese Patent Application No. 2020-039159 filed on Mar. 6, 2020, the entire disclosure of which is incorporated herein by reference.

### BACKGROUND OF THE INVENTION

### Field of the Invention

The present invention relates to an information processing technique for a vehicle.

### Description of the Related Art

There is known a vehicle that incorporates a sensor, such as millimeter wave radar or the like, for monitoring the periphery of a vehicle, and performs driving support based on targets such as other vehicles and the like detected by the sensor. On the other hand, dirt may adhere to such a sensor depending on the travel environment of the vehicle, and cause the performance of the sensor to degrade. Other than dust and mud, the dirt may also be snow, ice, or the like. Japanese Patent Laid-Open No. 2018-179554 discloses a technique for determining the presence/absence of dirt on the sensor.

Whether the sensor has not detected a target for a long time can be considered to be a reference for determining the presence/absence of dirt. However, problematically, using such a reference will take too much time to make a determination.

### SUMMARY OF THE INVENTION

An object of the present invention is to provide a technique that can determine the degradation of the performance of a sensor in a shorter time.

According to an aspect of the present invention, there is provided a vehicle information processing apparatus comprising:

a detection unit configured to detect a target outside a vehicle;

a communication unit configured to obtain position information of another vehicle by vehicle-to-vehicle communication; and

a determination unit configured to determine, based on the position information obtained by the communication unit and a detection result obtained by the detection unit, whether performance degradation of the detection unit has occurred.

Further features of the present invention will become apparent from the following description of exemplary embodiments (with reference to the attached drawings).

### BRIEF DESCRIPTION OF THE DRAWINGS

FIG. 1 is a block diagram of a vehicle and a control apparatus according to an embodiment;

FIG. 2 is a flowchart showing an example of processing executed by the vehicle control apparatus of FIG. 1;

FIG. 3 is a flowchart showing an example of processing executed by the vehicle control apparatus of FIG. 1;

FIG. 4A is a view showing an example of performance degradation of a detection unit;

FIG. 4B is a view showing an example of detection of another vehicle;

FIG. 5 is a flowchart showing an example of processing executed by the vehicle control apparatus of FIG. 1:

FIG. 6 is a flowchart showing an example of processing executed by the vehicle control apparatus of FIG. 1;

FIG. 7 is a flowchart showing an example of processing executed by a vehicle control apparatus of FIG. 1:

FIGS. 8A and 8B are views showing an example of a removal unit;

FIG. 9 is a flowchart showing an example of processing executed by a vehicle control apparatus of FIG. 1:

FIG. 10 is a flowchart showing an example of processing executed by a vehicle control apparatus of FIG. 1; and

FIG. 11 is a flowchart showing an example of processing executed by the vehicle control apparatus of FIG. 1.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

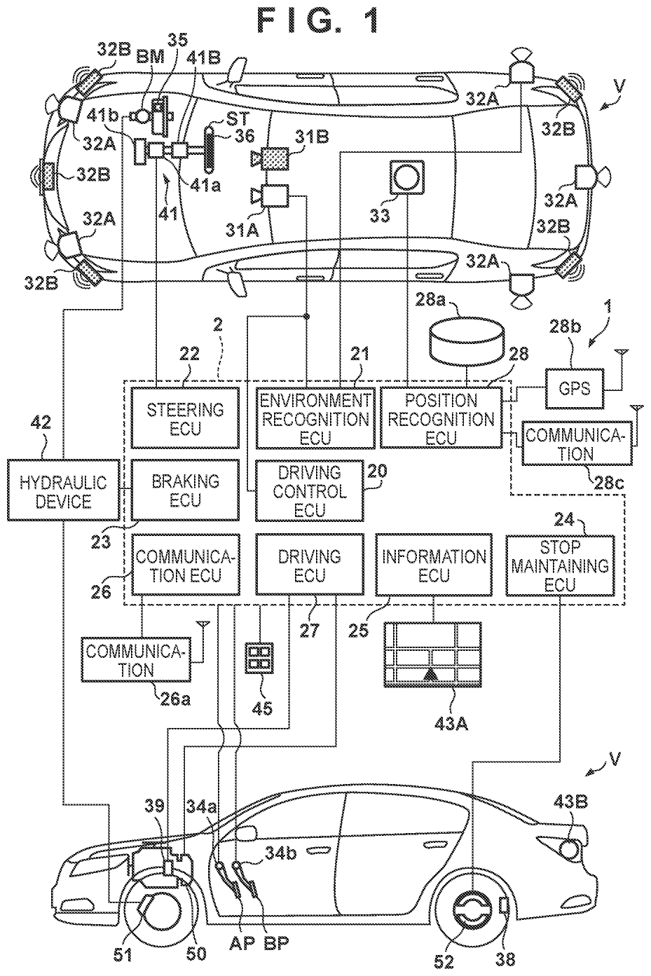

FIG. 1 is a block diagram of a vehicle V and a control apparatus (information processing apparatus) 1 according to an embodiment of the present invention. FIG. 1 shows the schematic arrangement of the vehicle V in a plan view and a side view. As an example, the vehicle V is a sedan-type four-wheeled passenger car.

The vehicle V according to this embodiment is, for example, a parallel-type hybrid vehicle. In this case, a power plant 50 that is a traveling driving unit configured to output a driving force to rotate the driving wheels of the vehicle V can include an internal combustion engine, a motor, and an automatic transmission. The motor can be used as a driving source configured to accelerate the vehicle V and can also be used as a power generator at the time of deceleration or the like (regenerative braking).

<Control Apparatus>

The arrangement of the control apparatus 1 that is an onboard apparatus of the vehicle V will be described with reference to FIG. 1. The control apparatus 1 includes an ECU group (control unit group) 2. The ECU group 2 includes a plurality of ECUs 20 to 28 configured to be communicable with each other. Each ECU includes a processor represented by a CPU, a storage device such as a semiconductor memory, an interface to an external device, and the like. The storage device stores programs to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment. Note that in FIG. 1, the names of representative functions of the ECUs 20 to 28 are added. For example, the ECU 20 is described as “driving control ECU”.

The ECU 20 executes control associated with traveling support including automated driving of the vehicle V. In automated driving, driving (acceleration or the like of the vehicle V by the power plant 50), steering, and braking of the vehicle V are automatically performed without requiring an operation of the driver. Additionally, in manual driving, the ECU 20 can execute, for example, traveling support control such as collision reduction brake or lane departure suppression. In the collision reduction brake, when the possibility of collision against a front obstacle rises, actuation of a brake device 51 is instructed to support collision avoidance. In the lane departure suppression, when the possibility of departure of the vehicle V from the traveling lane rises, actuation of an electric power steering device 41 is instructed to support lane departure.

The ECU 21 is an environment recognition unit configured to recognize the travel environment of the vehicle V based on the detection results of detection units 31A, 31B, 32A, and 32B configured to detect the state of the periphery of the vehicle V. The detection units 31A, 31B, 32A, and 32B are sensors that can detect a target outside the vehicle. In this embodiment, the detection units 31A and 31B are cameras (to be sometimes referred to as the cameras 31A and 31B hereinafter) that capture the front side of the vehicle V and are provided on the front portion of the roof on the in-vehicle side of the windshield of the vehicle V. When images captured by the cameras 31A and 31B are analyzed, the contour of a target or a division line (a white line or the like) of a lane on a road can be extracted.

In this embodiment, each detection unit 32A is a lidar (Light Detection and Ranging) (to be sometimes referred to as the lidar 32A hereinafter), and detects a target on the periphery of the vehicle V or measures the distance to a target. In this embodiment, five lidars 32A are provided, one at each corner of the front portion of the vehicle V, one at the center of the rear portion, and one on each side of the rear portion. Each detection unit 32B is a millimeter wave radar (to be sometimes referred to as the radar 32B hereinafter), and detects a target on the periphery of the vehicle V or measures the distance to a target. In this embodiment, five radars 32B are provided; one at the center of the front portion of the vehicle V, one at each corner of the front portion, and one at each corner of the rear portion.

The ECU 22 is a steering control unit configured to control the electric power steering device 41. The electric power steering device 41 includes a mechanism that steers the front wheels in accordance with the driving operation (steering operation) of the driver on a steering wheel ST. The electric power steering device 41 includes a driving unit 41a including a motor that generates a driving force (to be sometimes referred to as a steering assist torque) to assist the steering operation or automatically steer the front wheels, a steering angle sensor 41b, a torque sensor 41c that detects a steering torque (to be referred to as a steering burden torque which is discriminated from the steering assist torque) borne by the driver, and the like. The ECU 22 can also acquire the detection result of a sensor 36 configured to detect whether the driver is gripping the steering handle ST, and can monitor the grip state of the driver.

The ECU 23 is a braking control unit configured to control a hydraulic device 42. The braking operation of the driver on a brake pedal BP is converted into a liquid pressure by a brake master cylinder BM and transmitted to the hydraulic device 42. The hydraulic device 42 is an actuator capable of controlling the liquid pressure of hydraulic oil supplied to the brake device (for example, a disc brake device) 51 provided on each of the four wheels based on the liquid pressure transmitted from the brake master cylinder BM, and the ECU 23 drives and controls a solenoid valve and the like provided in the hydraulic device 42. At the time of braking, the ECU 23 can light a brake lamp 43B. This can raise the attention of a following vehicle to the vehicle V.

The ECU 23 and the hydraulic device 42 can form an electric servo brake. The ECU 23 can control, for example, distribution of a braking force by the four brake devices 51 and a braking force by regenerative braking of the motor provided in the power plant 50. The ECU 23 can also implement an ABS function, traction control, and the posture control function of the vehicle V based on the detection results of a wheel speed sensor 38 provided on each of the four wheels, a yaw rate sensor (not shown), and a pressure sensor 35 that detects the pressure in the brake master cylinder BM.

The ECU 24 is a stop maintaining control unit configured to control an electric parking brake device (for example, a drum brake) 52 provided on the rear wheels. The electric parking brake device 52 includes a mechanism that locks the rear wheels. The ECU 24 can control lock of the rear wheels and lock cancel by the electric parking brake device 52.

The ECU 25 is an internal notification control unit configured to control an information output device 43A that notifies information in the vehicle. The information output device 43A includes, for example, a head up display or a display device provided on an instrument panel or a sound output device. The information output device 43A may also include a vibration device. The ECU 25 causes the information output device 43A to output, for example, various kinds of information such as a vehicle speed and an outside temperature, information such as a route guide, and information about the state of the vehicle V.

The ECU 26 includes a communication device 26a for wireless communication. The communication device 26a can perform wireless communication to exchange information with a target that has a communication function. A target that has a communication function can be, for example, a vehicle (vehicle-to-vehicle communication), a fixed facility such as a traffic light, a traffic monitoring device, or the like (road-to-vehicle communication), or a person (a pedestrian, a cyclist, or the like) holding a portable terminal such as a smartphone or the like. The ECU 26 can also access a server or the like on the Internet via the communication device 26a and obtain various kinds of information such as weather information and the like.

The ECU 27 is a driving control unit configured to control the power plant 50. In this embodiment, one ECU 27 is assigned to the power plant 50. However, one ECU may be assigned to each of the internal combustion engine, the motor, and the automatic transmission. The ECU 27, for example, controls the output of the internal combustion engine or the motor or switches the gear range of the automatic transmission in correspondence with the vehicle speed or the driving operation of the driver detected by an operation detection sensor 34a provided on an accelerator pedal AP or an operation detection sensor 34b provided on the brake pedal BP. Note that the automatic transmission is provided with a rotation speed sensor 39 configured to detect the rotation speed of the output shaft of the automatic transmission as a sensor that detects the traveling state of the vehicle V. The vehicle speed of the vehicle V can be calculated from the detection result of the rotation speed sensor 39.

The ECU 28 is a position recognition unit configured to recognize the current position or track of the vehicle V. The ECU 28 performs control of a gyro sensor 33, a GPS sensor 28b, and a communication device 28c and information processing of a detection result or a communication result. The gyro sensor 33 detects the rotary motion of the vehicle V. The track of the vehicle V can be determined based on the detection result of the gyro sensor 33 and the like. The GPS sensor 28b detects the current position of the vehicle V. The communication device 28c performs wireless communication with a server that provides map information and traffic information and acquires these pieces of information. A database 28a can store accurate map information. The ECU 28 can more accurately specify the position of the vehicle V on a lane based on the map information and the like.

An input device 45 is arranged inside the vehicle so as to be operable by the driver and receives an instruction or information input by the driver.

<Example of Control>

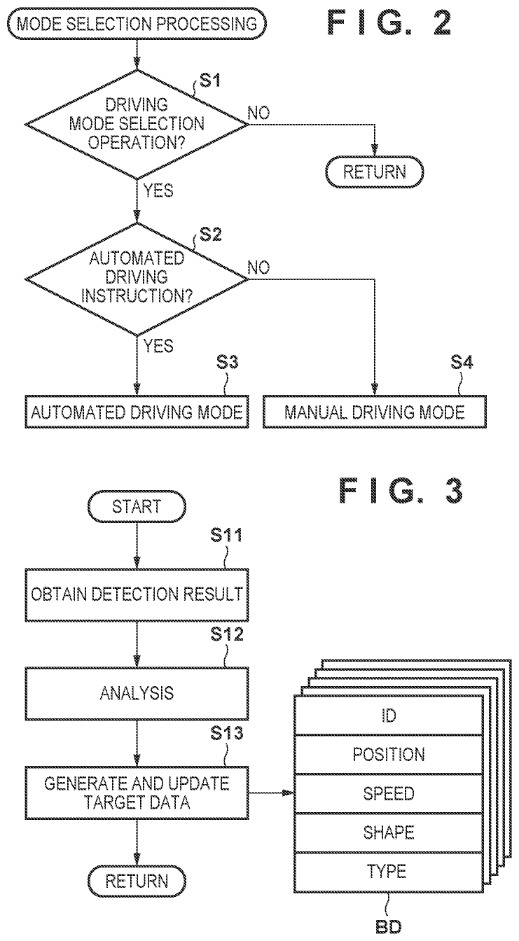

An example of control of the control apparatus 1 will be described. FIG. 2 is a flowchart showing mode selection processing of driving control executed by the ECU 20.

In step S1, it is determined whether a mode selection operation is performed by the driver. The driver can instruct switching between an automated driving mode and a manual driving mode by, for example, an operation on the input device 45. If a selection operation is performed, the process advances to step S2. Otherwise, the processing ends.

In step S2, it is determined whether the selection operation instructs automated driving. If the selection operation instructs automated driving, the process advances to step S3. If the selection operation instructs manual driving, the process advances to step S4. In step S3, the automated driving mode is set, and automated driving control is started. In step S4, the manual driving mode is set, and manual driving control is started. Current settings concerning the mode of driving control are notified from the ECU 20 to the ECUs 21 to 28 and recognized.

In the automated driving control, the ECU 20 outputs a control instruction to the ECUs 22, 23, and 27 to control the steering, braking, and driving of the vehicle V, thereby automatically making the vehicle V travel without the driving operation of the driver. The ECU 20 sets the traveling route of the vehicle V and causes the vehicle V to travel along the set traveling route by referring to the position recognition result of the ECU 28 or a target recognition result. In the manual driving control, driving, steering, and braking of the vehicle V are performed in accordance with the driving operation of the driver, and the ECU 20 executes traveling support control as needed.

<Recognition of Target>

Targets in the periphery of the vehicle V are recognized based on the detection results of the detection units 31A, 31B, 32A, and 32B. FIG. 3 shows generation/update processing of target data that is periodically executed by the ECU 21.

In step S11, the detection result of each detection unit is obtained. In step S12, each detection result obtained in step S11 is analyzed to recognize each target. In S13, target data is generated and updated. The ECU 21 stores and manages target object data BD in an internal storage device. The target object data BD is generated for each target, and if a target is recognized as an already known target in step S12, the contents of the corresponding target object data BD stored in the internal storage device are updated as needed. If a target is recognized as a new target in step S12, the corresponding target object data BD is newly generated for this target.

The target object data BD exemplified here includes an ID added to each target, the position information of the target, information of the speed of the movement of the target, information of the shape of the target, and the type of the target. The type of the target may include classifications such a fixed body and a moving body. The type of the moving body may further include classifications such as an automobile (four-wheeled vehicle), a motorcycle, a pedestrian, and the like.

<Determination of Performance Degradation of Detection Unit>

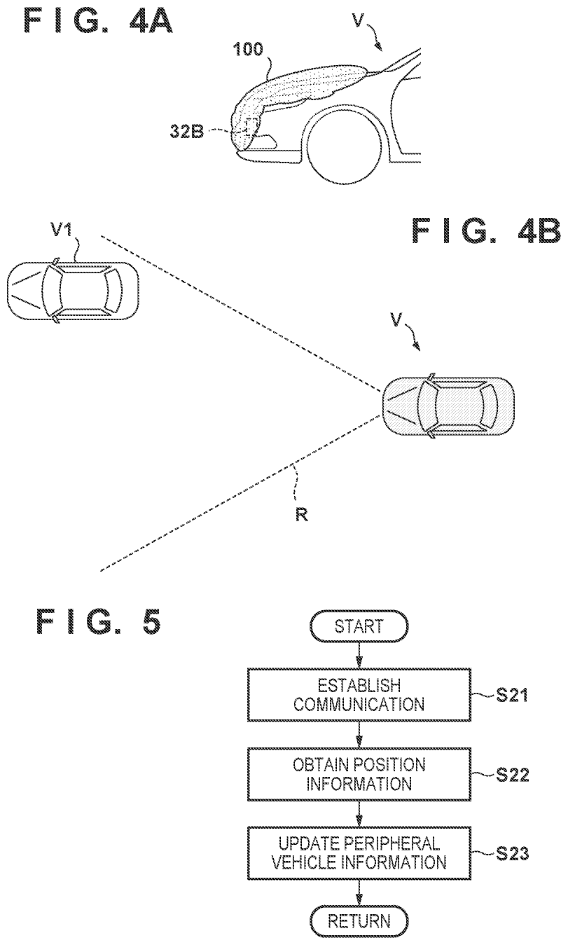

Dirt will adhere to the vehicle V through its use. For example, obstacles such as snow, ice, dust, and the like can adhere to the vehicle V. The presence of an obstacle within the detection ranges of the detection units 31A, 31B, 32A, and 32B will influence the detection performances of the respective detection units. FIG. 4A shows such an example. In the example of FIG. 4A, snow 100 has accumulated on the front portion of the vehicle V. The detection unit 32B may not be able to detect a target in front of the vehicle V due to the presence of the snow 100.

In the example of FIG. 4A, a time in which the detection unit 32B does not detect a target will continue. Alternatively, a time in which the detection result does not change will continue. Hence, this elapse of time can be used as a reference to determine whether the performance of the detection unit 32B has degraded. However, if the time to be used as the determination reference is set long, it will take time until the performance degradation is recognized from its occurrence, and the target recognition accuracy will degrade. On the other hand, shortening the time to be used as a determination reference will cause a determination error to occur more easily. For example, if the vehicle V is traveling through a desert, there may not be much change in the detection result of the detection unit 32B in the first place due to a lack of targets in the periphery of the vehicle. It may be determined erroneously that the performance of the detection unit 32B has degraded even though it has not.

Hence, in this embodiment, whether another vehicle has been detected will be used as a reference by using vehicle-to-vehicle communication to obtain the position information of the other vehicle. FIG. 4B shows such an example. In FIG. 4B, a detection range R exemplifies a detection range of the center detection unit 32B at the front portion of the vehicle V. The detection range R can be specified from the specification of the detection unit 32B and the current position of the vehicle V. Another vehicle V1 is present in the detection range R in the example shown in FIG. 4B.

The current position information of the other vehicle V1 is obtained from the other vehicle V1 by vehicle-to-vehicle communication between the self-vehicle V and the other vehicle V1. The other vehicle V1 is assumed here to have a function that can recognize its current position by a GPS sensor or the like. The self-vehicle V can determine, based on the obtained current position information, whether the position of the other vehicle V1 falls within the detection range R. If it is determined that the position of the other vehicle V1 falls within the detection range R and the detection unit 32B is not detecting a target corresponding to the other vehicle V1, it can be determined that the performance of the detection unit 32B has degraded. The processing will be described more specifically hereinafter.

<Obtainment of Position Information of Other Vehicle>

FIG. 5 is a flowchart showing an example of vehicle-to-vehicle communication processing that is repetitively executed by the ECU 26. In step S21, the communication device 26a is used to establish communication between the self-vehicle V and another vehicle present in the periphery. To establish communication, for example, the self-vehicle V broadcasts a connection request, and communication is established when the communication device of the other vehicle responds to this connection request. Note that at the point of time of the process of step S21, there may be another vehicle with which self-vehicle has already established communication by another process in the past. The information of each of the other vehicles with which communication has been established will be stored and managed as peripheral vehicle information in a storage device included in the ECU 26.

In step S22, the position information is requested from each of the other vehicles with which communication has been established, and the position information is obtained from each of the other vehicles. In step S23, the peripheral vehicle information is updated based on each piece of position information obtained in step S22. The current position of each of the other vehicles present in the periphery of the self-vehicle V can be recognized by referring to the peripheral vehicle information.

<Performance Degradation Determination Processing>

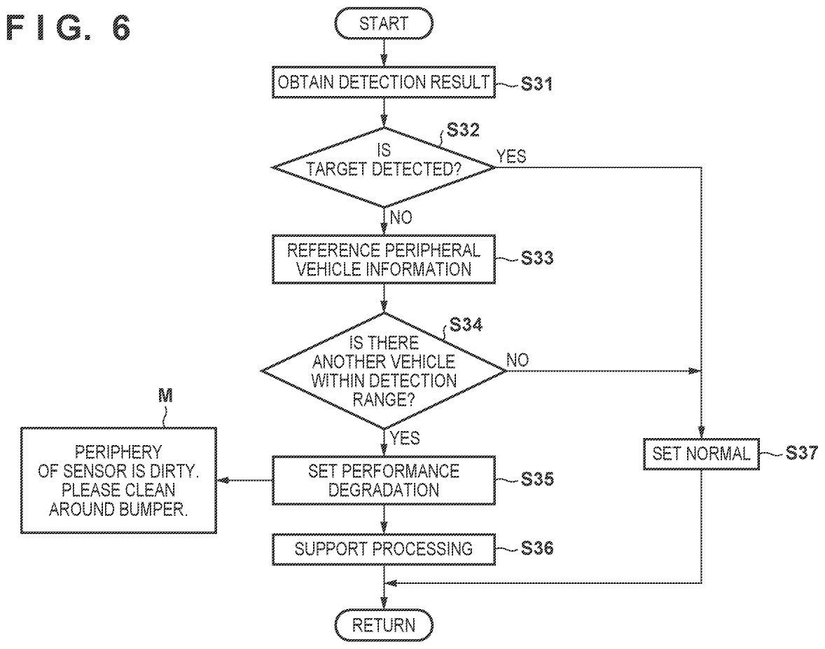

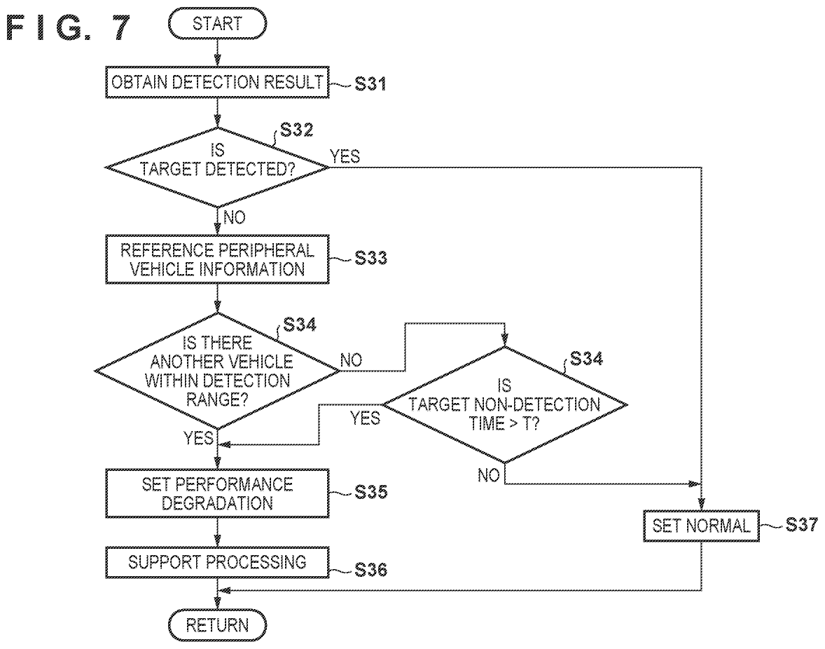

FIG. 6 is a flowchart showing an example of the determination processing that is repetitively executed by the ECU 21. An example in which the performance degradation of the detection unit 32B is determined will be described here. Five detection units 32B are provided in this embodiment. The processing of FIG. 6 can be performed individually for each detection unit 32B. Note that similar processing can also be applied to the determination of performance degradation of other detection units 31A, 31B, and 32A.

In step S31, the detection result of the detection unit 32B is obtained. In step S32, whether a target has been detected in the detection result obtained in step S31 is determined. A target here may include all targets or may be limited to a moving body such as a vehicle and the like. It will be determined that the performance has not degraded if a target has been detected. Subsequently, the process will advance to step S37, and “normal” will be set as the state information of this detection unit 32B. If it is determined that a target has not been detected, the process advances to step S33.

In step S33, the peripheral vehicle information is obtained from the ECU 26. Also, the current position and the track information of the self-vehicle V are obtained from the ECU 28. In step S34, whether another vehicle is present in the detection range R of the detection unit 32B is determined based on these pieces of information and the specification of the detection unit 32B. If the other vehicle is present, it will be determined that the performance of the detection unit 32B has degraded, and the process will advance to step S35. If the other vehicle is not present, it will be determined that the performance degradation has not occurred, and the process will advance to step S37.

In step S35, “performance degradation” is set as the state information of the detection unit 32B. It may be arranged so the detection result of this detection unit 32B will not be used for the recognition of the target shown in FIG. 3 while this setting is set. Support processing is executed in step S36. An occupant of the self-vehicle is notified here of the presence of an obstacle in the detection range of the detection unit 32B. The ECU 21 instructs the ECU 25 to perform the notification, and the ECU 25 uses the information output device 43A to notify the occupant by display or voice.

An example in which a notification M is displayed on the information output device 43A is shown as one example in FIG. 6. In this example, the occupant is notified of the fact that the periphery of the detection unit 32B has become dirty, and is prompted to clean the bumper which falls within the detection range R of the detection unit 32B. In the case of performance degradation due to accumulation of the snow 100 as shown in FIG. 4A, the performance of the detection unit can be recovered when the occupant removes the snow 100.

As described above, in this embodiment, the performance degradation of the detection unit 32B can be determined in a shorter time by using the position information of another vehicle by vehicle-to-vehicle communication.

### Second Embodiment

In the processing of FIG. 6 of the first embodiment, a detection unit 32B is immediately set to “normal” (step S37) if it is determined that another vehicle is not present in a detection range R of the detection unit 32B in step S34. However, it is possible to consider a case in which another vehicle is not present by chance due to low traffic in the periphery of the self-vehicle V. Hence, if a state in which a target is not detected has continued for a predetermined time, it may be determined that the performance of the detection unit 32B has degraded. FIG. 7 is a flowchart showing this example and is an example of processing performed alternatively to the example of the processing of FIG. 6. Processes different from those of the example of the processing of FIG. 6 will be described.

If it is determined in step S34 that another vehicle is not present in the detection range R of the detection unit 32B, the process advances to step S38. In step S38, whether a state (target non-detection time) in which a target is not detected continues beyond a threshold time T is determined. The measurement of the target non-detection time is started first when the detection unit 32B has stopped detecting a target, and is reset when a target is detected. The threshold time T is, for example, 3 min to 5 min.

If the target non-detection time has exceeded the threshold time T, the process advances to step S35, and the state information of the detection unit 32B will be set to “performance degradation”. If the target non-detection time has not exceeded the threshold time T, the process advances to step S37, and the state information of the detection unit 32B will be set to “normal”.

According to this embodiment, even in an environment where there are a small number of other vehicles, the performance degradation of the detection unit 32B can be determined.

### Third Embodiment

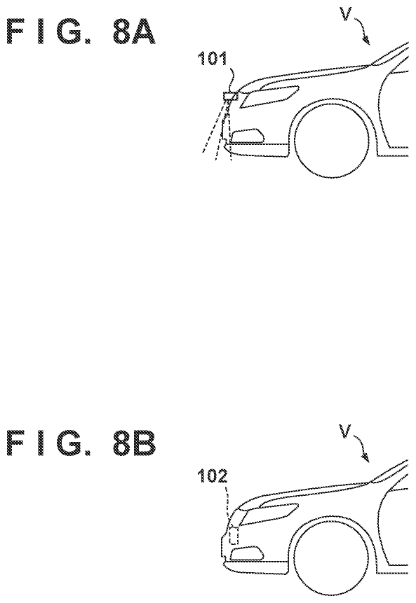

Although the first embodiment showed an example in which notification to an occupant is performed as the support processing of step S36, an obstacle removal unit may also be actuated. FIGS. 8A and 8B are views showing such an example.

A removal unit 101 of FIG. 8A is a washer that sprays a washer fluid. The removal unit 101 sprays, within the detection range of the detection unit 32B, water for washing on the surface (the bumper and its periphery in this example) of a vehicle V. This is effective for removing dust or mud if such dust or mud has adhered as an obstacle to the vehicle V.

A removal unit 102 of FIG. 8B is a heater that generates heat. The removal unit 102 is arranged inside the vehicle V so as to heat a component (the bumper and its periphery) of the vehicle V within the detection range of the detection unit 32B. This is effective for removing snow or ice when such snow or ice has adhered as an obstacle to the vehicle V.

### Fourth Embodiment

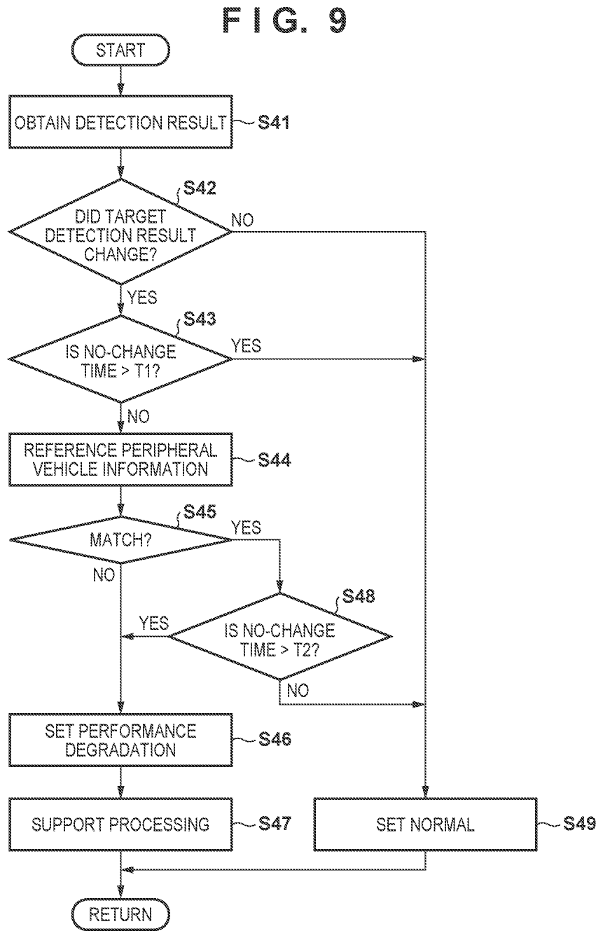

Although the determination operation of performance degradation of a detection unit 32B is triggered based on the lack of detection of a target in the first embodiment, the determination operation of performance degradation may also be triggered by the lack of change in the detection result of the detection unit 32B. FIG. 9 shows such an example and is a flowchart showing an example of the determination processing to be repetitively executed by an ECU 21. The processing of FIG. 9 may be executed alternatively to the processing of FIG. 6 (or FIG. 7) or may be executed in addition to the processing of FIG. 6 (or FIG. 7).

In step S41, the detection result of the detection unit 32B is obtained. In step S42, the detection result of step S41 is compared with a previous detection result to determine whether the detection result has changed. If the change of the detection result is less than a predetermined change amount, it will be determined that the detection result has not changed. If the detection result has changed, it will be determined that performance degradation has not occurred, and the process will advance to step S49 so that the state information of the detection unit 32B will be set to “normal”. If it is determined that the detection result has not changed, the process will advance to step S43.

In step S43, whether a state (no change time) in which the detection result of the detection unit 32B has not changed continues beyond a threshold time T1. The measurement of the no change time is started first when the detection result of the detection unit 32B has stopped changing, and is reset when the detection result has changed. The threshold time T1 is, for example, 10 sec to 30 sec.

In step S44, the peripheral vehicle information is obtained from an ECU 26. The current position and the track information of a self-vehicle V are obtained from an ECU 28. Subsequently, whether the detection result of the detection unit 32B matches these pieces of information is determined in step S45. For example, it will be determined that the detection result does not match the obtained pieces of information if the detection unit 32B has not detected the presence of another vehicle even though the other vehicle is present in a detection range R of the detection unit 32B.

If the detection result does not match the obtained pieces of information, it will be determined that the performance of the detection unit 32B has degraded, and the process will advance to step S46. If the detection result matches the obtained pieces of information, the process advances to step S48. In step S46, “performance degradation” is set as the state information of the detection unit 32B. It may be arranged so the detection result of this detection unit 32B will not be used for target recognition shown in FIG. 3 while this setting is set. In step S47, support processing is executed. This processing is similar to that of step S36 of FIG. 6.

In step S48, whether the no change time continues beyond a threshold time T2 is determined. The threshold time T2 is, for example, 3 min to 5 min. In a manner similar to the second embodiment, in an environment where there are a small number of other vehicles, the determination of step S48 is a determination performed under the intention of determining the performance degradation of the detection unit 32B, and it is also possible to adopt processing which does not perform this determination. If the no change time has exceeded the threshold time T2, the process advances to step S46. If the no change time has not exceeded the threshold time T2, the process advances to step S49.

According to this embodiment, even in a case in which the detection unit 32B is detecting some kind of a target, it is possible to determine whether the performance of this detection unit has degraded.

### Fifth Embodiment

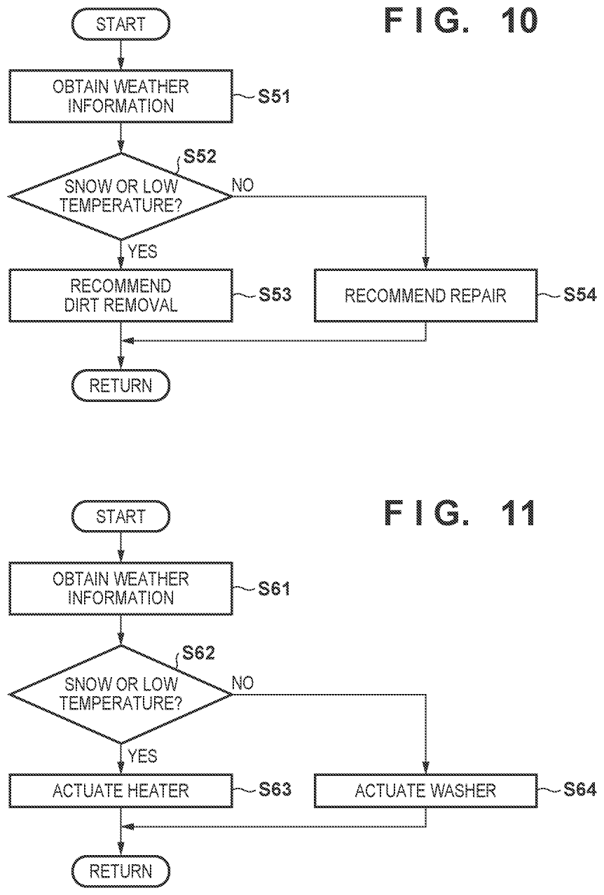

In the support processing of step S36 of FIG. 6 and that of step S47 of FIG. 9, the processing contents may be changed in consideration of the weather. For example, at a time of snowfall or low temperature, the cause of performance degradation of a detection unit 32B is highly likely to be accumulation of snow or buildup of ice on a vehicle V. In such cases, it is comparatively easy for an occupant to remove such obstacles. On the other hand, in a case in which the cause of performance degradation of the detection unit 32B is not the accumulation of snow or the buildup of ice on the vehicle V, it may be difficult for the occupant to perform recovery. Hence, the contents of the notification to the occupant may be set to change in accordance with the weather. FIG. 10 is a flowchart showing such an example and exemplifies the specific contents of the support processing.

In step S51, the vehicle V obtains the weather of an area where the self-vehicle is traveling. The weather information can be obtained, for example, from an information provision server on the Internet via an ECU 26. Alternatively, the weather information may be obtained from various kinds of sensors (a temperature sensor, a humidity sensor, a sunlight sensor, and the like) provided in the vehicle V. In step S52, whether the weather of the area where the vehicle V is traveling is snowfall or low temperature (for example, a temperature below freezing) is determined based on the weather information obtained in step S51. If snowfall or low temperature is determined, it is determined that the cause of the performance degradation of the detection unit 32B is highly likely to be accumulation of snow or buildup of ice on the vehicle V, and the process advances to step S53. In step S53, a content recommending the removal of the dirt is set as the contents of the notification to the occupant. For example, this content is set as the contents of a notification M exemplified in FIG. 6.

In step S52, if it is determined that the weather of the area where the vehicle V is traveling is not snowfall or low temperature, it will be determined that the recovery of the performance degradation of the detection unit 32B is difficult, and the process will advance to step S54. In step S54, a content recommending repair will be set to the contents of the notification to the occupant. For example, the notification will advise the occupant to take the vehicle V to an auto repair shop and have the vehicle be checked by an expert.

Next, in the support processing of step S36 of FIG. 6 and that of step S47 of FIG. 9, the processing contents may be changed by the operation of a removal unit in consideration of the weather. For example, at a time of snowfall or low temperature, the cause of performance degradation of the detection unit 32B is highly likely to be accumulation of snow or buildup of ice on the vehicle V. In such a case, while the actuation of a heater 102 will be effective, it may be difficult to remove the obstacle by actuating a washer 101. On the other hand, in a case in which the cause of the performance degradation of the detection unit 32B is dust or mud that has adhered to the vehicle V, while the actuation of the washer 101 will be effective, it will be difficult to remove the obstacle by the actuation of the heater 102. Hence, the removal operation of each removal unit may be switched in accordance with the weather.

FIG. 11 is a flowchart showing such an example and exemplifies the specific contents of the support processing. The example of FIG. 11 assumes a case in which the vehicle V includes both the washer 101 and the heater 102.

In step S61, the vehicle V obtains the weather information of an area where the self-vehicle is traveling. This process is similar to that of step S51. In step S62, whether the weather of the area where the vehicle V is traveling is snowfall or low temperature (for example, the temperature is below freezing) is determined based on the weather information obtained in step S61. If it is determined to be snowfall or low temperature, it will be determined that the cause of the performance degradation of the detection unit 32B is highly likely to be accumulation of snow or buildup of ice on the vehicle V, and the process advances to step S63. In step S63, the heater 102 is actuated to remove the obstacle.

In step S62, if it is determined that the weather of the area where the vehicle V is traveling is not snowfall or low temperature, it will be determined that the cause of the performance degradation of the detection unit 32B is highly likely to be adherence of dust or mud to the vehicle V, and the process will advance to step S64. In step S64, the washer 101 is actuated to remove the obstacle.

Note that in a case in which the vehicle V includes only the washer 101, the occupant may be notified of the occurrence of the performance degradation without performing the removal operation of step S63. Also, in a case in which the vehicle V includes only the heater 102, it may be arranged so the occupant will be notified of the occurrence of the performance degradation without performing the removal operation of step S64.

### Summary of Embodiments

The above-described embodiments disclose at least the following embodiments.

1. A vehicle information processing apparatus (1) according to above-described embodiment comprises

a detection unit (32B) configured to detect a target outside a vehicle;

a communication unit (26) configured to obtain position information of another vehicle by vehicle-to-vehicle communication; and

a determination unit (21) configured to determine, based on the position information obtained by the communication unit and a detection result obtained by the detection unit, whether performance degradation of the detection unit has occurred.

According to this embodiment, a technique that can determine the performance degradation of a sensor in shorter time can be provided.

2. In the above-described embodiment,

in a case in which the detection unit does not detect that the other vehicle is present in a position indicated by the position information, the determination unit determines that the performance degradation of the detection unit has occurred (S31-S35).

According to this embodiment, the performance degradation can be determined by using the result of vehicle-to-vehicle communication.

3. In the above-described embodiment,

in a case in which the detection unit does not detect the target, the determination unit determines, based on the position information obtained by the communication unit and the detection result of the detection unit, whether the performance degradation of the detection unit has occurred (S31-S35).

According to this embodiment, the determination of performance degradation of the detection unit can be performed in a case in which the possibility of the performance degradation of the detection unit is high. Hence, it will be possible to suppress the determination frequency from increasing.

4. In the above-described embodiment,

in a case in which a target detection result of the detection unit does not change for a first time, the determination unit determines, based on the position information obtained by the communication unit and the detection result of the detection unit, whether the performance degradation of the detection unit has occurred (S41-S46).

According to this embodiment, the performance degradation of the detection unit can be determined even in a case in which the detection unit is detecting some kind of a target.

5. In the above-described embodiment,

in a case in which the detection unit does not detect that the another vehicle is present in a position indicated by the position information, the determination unit determines that the performance degradation of the detection unit has occurred (S41-S46), and

in a case in which the target detection result of the detection unit does not change for a second time which is longer than the first time, the determination unit determines that the performance degradation of the detection unit has occurred (S48).

According to this embodiment, the occurrence of the performance degradation of the detection unit can be determined even in a case in which another vehicle is not present in the periphery.

6. The vehicle information processing apparatus (1) according to the above-described embodiment further comprises

a notification unit (25) configured to notify, in a case in which the determination unit determines that the performance degradation of the detection unit has occurred, an occupant of the presence of an obstacle in a detection range of the detection unit.

According to this embodiment, the occupant can be notified of the occurrence and the cause of the performance degradation.

7. The vehicle information processing apparatus (1) according to the above-described embodiment further comprises

an obtaining unit (S51) configured to obtain information related to weather,

wherein the notification unit sets a notification content based on the information obtained by the obtaining unit (S53, S54).

According to this embodiment, the occupant can be notified of the occurrence and the cause of the performance degradation in consideration of the weather.

8. The vehicle information processing apparatus (1) according to the above-described embodiment further comprises

a removal unit (101, 102) configured to perform, in a case in which the determination unit determines that the performance degradation of the detection unit has occurred, a removal operation of an obstacle on a detection range of the detection unit.

According to this embodiment, performance recovery of the detection unit can be performed automatically.

9. The vehicle information processing apparatus (1) according to the above-described embodiment further comprises

an obtaining unit (S61) configured to obtain information related to weather,

wherein the removal unit performs the removal operation based on the information obtained by the obtaining unit (S63, S64).

According to this embodiment, the performance recovery of the detection unit can be performed automatically in consideration of the weather.

The invention is not limited to the foregoing embodiments, and various variations/changes are possible within the spirit of the invention.

What is claimed is:

1. A vehicle information processing apparatus comprising:
a detection unit configured to detect a target outside a vehicle;
a communication unit configured to obtain position information of another vehicle by vehicle-to-vehicle communication; and
a determination unit configured to determine, based on the position information obtained by the communication unit and a detection result obtained by the detection unit, whether performance degradation of the detection unit has occurred.

2. The apparatus according to claim 1, wherein in a case in which the detection unit does not detect that the other vehicle is present in a position indicated by the position information, the determination unit determines that the performance degradation of the detection unit has occurred.

3. The apparatus according to claim 1, wherein in a case in which the detection unit does not detect the target, the determination unit determines, based on the position information obtained by the communication unit and the detection result of the detection unit, whether the performance degradation of the detection unit has occurred.

4. The apparatus according to claim 1, wherein in a case in which a target detection result of the detection unit does not change for a first time, the determination unit determines, based on the position information obtained by the communication unit and the detection result of the detection unit, whether the performance degradation of the detection unit has occurred.

5. The apparatus according to claim 4, wherein in a case in which the detection unit does not detect that the another vehicle is present in a position indicated by the position information, the determination unit determines that the performance degradation of the detection unit has occurred, and
in a case in which the target detection result of the detection unit does not change for a second time which is longer than the first time, the determination unit determines that the performance degradation of the detection unit has occurred.

6. The apparatus according to claim 1, further comprising:
a notification unit configured to notify, in a case in which the determination unit determines that the performance degradation of the detection unit has occurred, an occupant of the presence of an obstacle in a detection range of the detection unit.

7. The apparatus according to claim 6, further comprising:
an obtaining unit configured to obtain information related to weather,
wherein the notification unit sets a notification content based on the information obtained by the obtaining unit.

8. The apparatus according to claim 1, further comprising:
a removal unit configured to perform, in a case in which the determination unit determines that the performance degradation of the detection unit has occurred, a removal operation of an obstacle on a detection range of the detection unit.

9. The apparatus according to claim 8, further comprising:
an obtaining unit configured to obtain information related to weather,
wherein the removal unit performs the removal operation based on the information obtained by the obtaining unit.
